(19) United States
(12) Patent Application Publication
(10) Pub. No.: US 2025/0280475 A1
(43) Pub. Date: Sep. 4, 2025

(54) AEROSOL GENERATING DEVICE AND MICROWAVE HEATING ASSEMBLY THEREOF

(71) Applicant: SMOORE INTERNATIONAL HOLDINGS LIMITED, George Town (KY)

(72) Inventors: Yang DENG, Shenzhen (CN); Jing DU, Shenzhen (CN); Feng LIANG, Shenzhen (CN); Yonghai LAN, Shenzhen (CN)

(21) Appl. No.: 19/213,269

(22) Filed: May 20, 2025

Related U.S. Application Data
(63) Continuation of application No. PCT/CN2023/105281, filed on Jun. 30, 2023.

(30) Foreign Application Priority Data
Nov. 21, 2022 (CN) 202223082483.3

(51) Int. Cl. H05B 6/80; A24F 40/46; H05B 6/70

(52) U.S. Cl. CPC H05B 6/802; A24F 40/46; H05B 6/70

(57) ABSTRACT

A microwave heating assembly for an aerosol generating device includes: a microwave heating unit includes: an outer conductor unit in a cylindrical shape, an inner conductor unit arranged in the outer conductor unit, and a feed hole communicating an interior of the outer conductor unit with an outside; a radio frequency board; and a microwave feed unit includes: an inner conductor arranged in the feed hole and comprising a feed end and an access end. The feed end is in ohmic contact with an inner side of the outer conductor unit or the inner conductor unit. An access end is in ohmic contact with the radio frequency board.

### CROSS-REFERENCE TO PRIOR APPLICATION

This application is a continuation of International Patent Application No. PCT/CN2023/105281, filed on Jun. 30, 2023, which claims priority to Chinese Patent Application No. 202223082483.3, filed on Nov. 21, 2022. The entire disclosure of both applications is hereby incorporated by reference herein.

### FIELD

The present invention relates to the field of aerosol generating technologies, and in particular, to an aerosol generating device and a microwave heating assembly thereof.

### BACKGROUND

In the related art, an aerosol generating article generates an aerosol through a microwave heating-type aerosol generating device. However, the microwave heating-type aerosol generating device generally includes a microwave feed unit, and a microwave heating unit and a radio frequency board that are connected by using the microwave feed unit.

The microwave feed unit is generally a radio frequency connector assembly, and the radio frequency connector assembly includes a male radio frequency terminal and a female radio frequency terminal. The female radio frequency terminal is embedded on the microwave heating unit, the male radio frequency terminal is soldered onto the radio frequency board, and the male radio frequency terminal is connected to the female radio frequency terminal, thereby achieving a good connection between the microwave heating unit and the radio frequency board.

However, the radio frequency connector assembly in the related art has at least the following disadvantages:

1. There are two types of radio frequency terminals: a male radio frequency terminal and a female radio frequency terminal exist. Connection is inconvenient, assembly time is relatively long, reliability is relatively low, and an insertion loss is also increased.

2. An radio frequency terminal has a high price. Because there are two types of radio frequency terminals, costs are relatively increased.

### SUMMARY

In an embodiment, the present invention provides a microwave heating assembly for an aerosol generating device, the microwave heating assembly comprising: a microwave heating unit, comprising: an outer conductor unit in a cylindrical shape, an inner conductor unit arranged in the outer conductor unit, and a feed hole communicating an interior of the outer conductor unit with an outside; a radio frequency board; and a microwave feed unit, comprising: an inner conductor arranged in the feed hole and comprising a feed end and an access end, wherein the feed end is in ohmic contact with an inner side of the outer conductor unit or the inner conductor unit, and wherein an access end is in ohmic contact with the radio frequency board.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of a radio frequency board by disassembling a microwave heating assembly according to Embodiment 1 of the present invention;

FIG. 2 is a longitudinal structural cross-sectional view of the microwave heating assembly according to Embodiment 1 of the present invention;

FIG. 3 is a longitudinal structural cross-sectional view of a microwave heating unit in a disassembled state according to Embodiment 1 of the present invention;

FIG. 4 is a schematic structural diagram of a microwave feed unit according to Embodiment 1 of the present invention;

FIG. 5 is a longitudinal structural cross-sectional view of the microwave feed unit in FIG. 4;

FIG. 6 is a longitudinal structural cross-sectional view of the microwave feed unit in FIG. 4 in a disassembled state;

FIG. 7 is a schematic structural diagram of a microwave heating unit and a microwave feed unit in an assembled state according to Embodiment 2 of the present invention;

FIG. 8 is a longitudinal structural cross-sectional view of the microwave heating unit and the microwave feed unit in FIG. 7 in the assembled state;

FIG. 9 is a longitudinal structural cross-sectional view of a microwave heating unit in a disassembled state according to Embodiment 2 of the present invention;

FIG. 10 is a schematic structural diagram of an inner conductor unit according to Embodiment 2 of the present invention;

FIG. 11 is a schematic structural diagram of a radio frequency board by disassembling a microwave heating assembly according to Embodiment 3 of the present invention;

FIG. 12 is a schematic structural diagram of a microwave heating unit and a microwave feed unit in an assembled state according to Embodiment 3 of the present invention;

FIG. 13 is a longitudinal structural cross-sectional view of the microwave heating unit and the microwave feed unit in FIG. 12 in the assembled state; and

FIG. 14 is a longitudinal structural cross-sectional view of the microwave heating unit and the microwave feed unit in FIG. 12 in a disassembled state.

### DETAILED DESCRIPTION

In an embodiment, the present invention provides an improved aerosol generating device and a microwave heating assembly thereof.

In an embodiment, the present invention provides for constructing a microwave heating assembly, used in an aerosol generating device, including:
a microwave heating unit, including:
an outer conductor unit in a cylindrical shape, an inner conductor unit arranged in the outer conductor unit, and a feed hole communicating the interior of the outer conductor unit with the outside;
a radio frequency board; and
a microwave feed unit, including:
an inner conductor arranged in the feed hole and including a feed end and an access end, where the feed end is in ohmic contact with the inner side of the outer conductor unit or the inner conductor unit, and the access end is in ohmic contact with the radio frequency board.

In some embodiments, the microwave feed unit further includes a connecting conductor arranged at the periphery of an opening of the feed hole and protruding toward the outside; and the microwave heating unit is connected to the radio frequency board by using the connecting conductor.

In some embodiments, the microwave feed unit further includes an outer conductor; and the outer conductor includes:
a mounting portion, including a first surface, a second surface opposite to the first surface, and a first through hole running through the first surface and the second surface; the first surface is relatively away from the outer conductor unit; and the connecting conductor is fitted to the first surface; and
an embedded portion, configured in a cylindrical shape and embedded in the feed hole, where the end of the embedded portion close to the mounting portion is fitted to the second surface, and a hollow channel of the embedded portion is in communication with the first through hole.

In some embodiments, the connecting conductor is integrally fitted to the first surface; or the connecting conductor is in ohmic contact with the first surface.

In some embodiments, at least one pair of connecting conductors are provided, and are symmetrically distributed on two opposite sides of an opening of the first through hole.

In some embodiments, the outer conductor further includes a snap portion arranged at the outer periphery of the embedded portion, the snap portion is engaged on the inner wall surface of the feed hole, and the snap portion is in ohmic contact with the outer conductor unit.

In some embodiments, the snap portion includes a snap ring sleeved at the outer periphery of the embedded portion.

In some embodiments, the feed hole includes:
a first hole segment close to the inner conductor unit, where the inner diameter of the first hole segment fits the outer diameter of the embedded portion; and
a second hole segment coaxially connected to the first hole segment, where the inner diameter of the second hole segment is greater than the inner diameter of the first hole segment;
and the shape of the inner wall of the second hole segment fits the snap portion.

In some embodiments, the microwave feed unit further includes a dielectric layer between the outer conductor and the inner conductor, where the dielectric layer is arranged in the through hole and/or the hollow channel.

In some embodiments, the inner conductor is of a straight-line, needle-like structure, and is coaxially arranged in the first through hole and the hollow channel.

In some embodiments, the access end extends out of the first through hole, and is flush with the surface of the connecting conductor away from the microwave heating unit.

In some embodiments, a first spacing is provided between a feedpoint of the radio frequency board and the first surface, and the size of the first spacing is not less than 0.5 mm; and

a second spacing is provided between the feedpoint of the radio frequency board and the wall surface of the connecting conductor facing the inner conductor, and the size of the second spacing is not less than 0.5 mm.

In some embodiments, the connecting conductor is integrally fitted to the outer surface of the microwave heating unit, or the connecting conductor is in ohmic contact with the outer surface of the microwave heating unit.

In some embodiments, at least one pair of connecting conductors are provided, and are symmetrically distributed on two opposite sides of the opening of the feed hole.

In some embodiments, the inner wall surface of the feed hole forms a circular columnar channel.

In some embodiments, the microwave feed unit further includes a dielectric layer arranged in the feed hole, the outer diameter of the dielectric layer fits the hole size of the feed hole, and the dielectric layer is between the inner wall surface of the feed hole and the outer wall surface of the inner conductor.

In some embodiments, the inner conductor is of a straight-line, needle-like structure, and is coaxial with the feed hole.

In some embodiments, the access end extends out of the feed hole, and is flush with the surface of the connecting conductor away from the microwave heating unit.

In some embodiments, a third spacing is provided between a feedpoint of the radio frequency board and the outer surface of the microwave heating unit, and the size of the third spacing is not less than 0.5 mm; and

a fourth spacing is provided between the feedpoint of the radio frequency board and the wall surface of the connecting conductor facing the inner conductor, and the size of the fourth spacing is not less than 0.5 mm.

In some embodiments, the connecting conductor is further provided with an avoidance portion recessed along the wall surface of the connecting conductor facing the inner conductor, and the avoidance portion is formed at a position that is of the wall surface of the connecting conductor facing the inner conductor and that is opposite to the inner conductor.

In some embodiments, the outer conductor unit is cylindrical and includes a first end, a second end, and a cavity between the first end and the second end; and

the inner conductor unit is coaxially arranged in the cavity and includes a first fixed end and a first free end, the first fixed end is connected to the second end, and the first free end extends toward the first end.

In some embodiments, the outer conductor unit includes a conductor side wall in a cylindrical shape, and the conductor side wall includes a first open end and a second open end that are opposite.

In some embodiments, the inner conductor unit includes:

a conductor column, including a second fixed end and a second free end; and the second fixed end is coaxially connected to the inner side of the outer conductor unit, and the second free end extends toward the first open end.

In some embodiments, the outer conductor unit further includes a conductor end wall, and the conductor end wall integrally blocks at the second open end; and

the conductor column includes a first column portion and a second column portion that are coaxially connected, and the second column portion is embedded in the conductor end wall and is in ohmic contact with the conductor end wall; and the first column portion extends from the end of the second column portion close to the first open end toward the first open end.

In some embodiments, the conductor side wall includes a first cylinder segment and a second cylinder segment that are coaxially connected, the first cylinder segment is relatively away from the second end of the outer conductor unit, and the inner diameter of the first cylinder segment is less than the inner diameter of the second cylinder segment; and

the conductor column includes a third column portion and a fourth column portion that are coaxially connected, the fourth column portion is embedded in the second cylinder segment, and the outer surface of the fourth column portion is attached to the inner wall surface of the second cylinder segment and is in ohmic contact with the second cylinder segment; and the diameter of the third column portion is less than the diameter of the first cylinder segment, and the third column portion is located in the first cylinder segment.

In some embodiments, the microwave heating unit further includes a pin configured to fix the fourth column portion in the second cylinder segment; and the pin passes through the outer peripheral side wall of the second cylinder segment, and is inserted into the fourth column portion.

In some embodiments, a second bump is arranged on the second cylinder segment for limiting the embedding of the fourth column portion in the circumferential direction, and the second bump protrudes inward along the inner wall surface of the second cylinder segment; and the fourth column portion is provided with a through groove matching the second bump and recessed inward along the outer peripheral side wall of the fourth column portion.

In some embodiments, a first bump is arranged at a position on the conductor side wall close to the second open end; and

the feed hole radially runs through the conductor side wall and the first bump, and is formed in the conductor side wall and the first bump.

In some embodiments, the feed hole runs through the conductor end wall in the direction parallel to the axial direction of the outer conductor unit and is formed on the conductor end wall.

In some embodiments, the feed hole runs through the fourth column portion in the direction parallel to the axial direction of the outer conductor unit and is formed in the fourth column portion.

In some embodiments, a first insertion hole extending in the radial direction of the conductor column is provided on the outer peripheral wall of the conductor column, and the first insertion hole is opposite to the feed hole; and

the feed end is inserted into the first insertion hole, and is in ohmic contact with the conductor column.

In some embodiments, the inner conductor unit further includes an extending portion fitted to the outer surface of the conductor column, and the extending portion extends outward in the direction perpendicular to the axis direction of the conductor column and is in ohmic contact with the feed end.

In some embodiments, the extending portion is provided with a second insertion hole for inserting the feed end, and an opening of the second insertion hole is opposite to the feed hole.

In some embodiments, the inner conductor unit further includes:

a conductor disk, coaxially connected to the second free end, where the diameter of the conductor disk is greater than the diameter of the conductor column and less than the inner diameter of the cavity.

In some embodiments, the inner conductor unit further includes:

a probe device in an elongated shape, where one end of the probe device is embedded in the conductor disk, and the other end of the probe device extends toward the first open end.

In some embodiments, the microwave heating assembly further includes an accommodating base mounted on the first open end, the accommodating base includes an accommodating portion configured to accommodate an aerosol generating article, and the accommodating portion is located in the cavity.

In the present invention, an aerosol generating device is further constructed, including a battery assembly and the microwave heating assembly. The battery assembly is electrically connected to the radio frequency board.

Implementation of the present invention has the following beneficial effects: In the present invention, the two ends of the inner conductor are respectively directly connected to the radio frequency board and the microwave heating unit, thereby reducing a component quantity of the radio frequency connector assembly, reducing costs, and improving reliability of a connection between the microwave heating unit and the radio frequency board.

List of reference numerals: first microwave heating assembly 100;
first microwave heating unit 1; first microwave feed unit 2; radio frequency board 3;
first outer conductor unit 11; first inner conductor unit 12; first accommodating base 13; first feed hole 14;
first end 111; second end 112; first conductor side wall 113; first conductor end wall 114; first cavity 115; first bump 116; sixth side surface 1161; mounting hole 117; first conductor column 121; first conductor disk 122; first probe device 123; first column portion 1211; second column portion 1212; first insertion hole 1213; first accommodating portion 131; first fixing portion 132; positioning rib 133; support rib 134; air inlet gap 135; accommodating cavity 1311; second through hole 1321; first hole segment 141; second hole segment 142; first snap slot 143;
first outer conductor 21; first inner conductor 22; first dielectric layer 23; first connecting conductor 24; mounting portion 211; embedded portion 212; snap portion 213; first surface 2111; second surface 2112; first through hole 2113; first needle segment 221; second needle segment 222; access end 2211; feed end 2221; first side surface 241; second side surface 242;
second microwave heating assembly 100a;
second microwave heating unit 1a;
second outer conductor unit 11a; second inner conductor unit 12a; second accommodating base 13a; second feed hole 14a; second conductor side wall 113a; perforation 118a; second bump 119a; second cavity 115a; first cylinder segment 1131a; second cylinder segment 1132a; step surface 1133a; second conductor column 121a; second conductor disk 122a; second probe device 123a; third column portion 1211a; fourth column portion 1212a; second insertion hole 1213a; extending portion 1214a; through groove 1215a;
third microwave heating assembly 100b;
second microwave feed unit 2b; third feed hole 14b; second connecting conductor 24b; second inner conductor 22b; second dielectric layer 23b; third side surface 241b; fourth side surface 242b; fifth side surface 243b; avoidance portion 2431b; third needle segment 221a; and fourth needle segment 222a.

To provide a clearer understanding of the technical features, objectives, and effects of the present invention, specific implementations of the present invention are described in detail with reference to the accompanying drawings. In the following descriptions of this application, it should be understood that orientation or position relationships indicated by the terms such as “front”, “rear”, “on”, “below”, “left”, “right”, “longitudinal”, “latitudinal”, “vertical”, “horizontal”, “top”, “bottom”, “inside”, “outside”, “head”, and “tail” are based on orientation or position relationships shown in the accompanying drawings, and the orientation or position relationships are used only for ease of describing of the technical solution, rather than indicating that the mentioned apparatus or element needs to have a particular orientation or constructed and operated in a particular orientation. Therefore, such terms should not be construed as a limitation to the present invention.

It should be further noted that unless otherwise explicitly specified and defined, terms such as “mounted”, “connected”, “connection”, “fixed”, and “arranged” should be understood in a broad sense. For example, a connection may be a fixed connection, a detachable connection, or an integral connection; the connection may be a mechanical connection or an electrical connection; or the connection may be a direct connection, an indirect connection through an intermediate medium, internal communication between two elements, or an interaction relationship between two elements. When an element is being “above” or “below” another element, the element can be “directly” or “indirectly” located above the another element, or one or more intermediate elements may exist. The terms such as “first”, “second”, and “third” are merely intended for case of describing of the technical solution, and shall not be understood as indicating or implying relative significance or implicitly indicating the number of indicated technical features. Therefore, a feature defined by the terms such as “first”, “second”, and “third” may explicitly or implicitly include one or more of the features. A person of ordinary skill in the art may understand the specific meanings of the foregoing terms in the present invention according to specific situations.

In the following descriptions, for the purpose of description rather than limitation, specific details such as specific system structures, and technologies are proposed to thoroughly understand the embodiments of the present invention. However, it should be clear to a person skilled in the art that the present invention may also be implemented in other embodiments without these specific details. In other cases, detailed descriptions of well-known systems, apparatuses, circuits, and methods are omitted, so that the present invention is described without being obscured by unnecessary details.

According to the present invention, an aerosol generating device is constructed. The aerosol generating device can heat an aerosol generating article by using microwaves for atomization to generate an aerosol, for a user to inhale. In some embodiments, the aerosol generating article is a solid-state aerosol generating article such as a processed plant leaf product. It may be understood that, in some other embodiments, the aerosol generating article may be a liquid aerosol generating article.

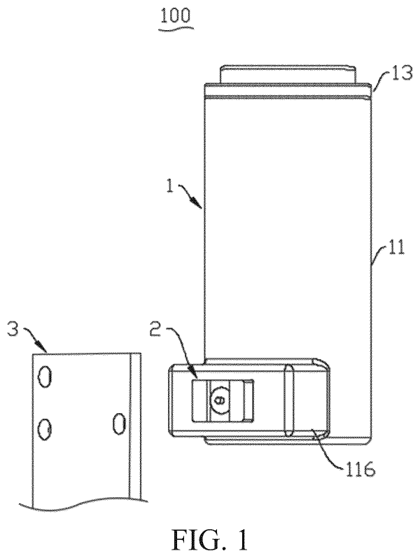

Referring to FIG. 1, in Embodiment 1, the aerosol generating device may include a first microwave heating assembly 100 and a battery assembly. The first microwave heating assembly 100 includes a first microwave heating unit 1, a first microwave feed unit 2, and a radio frequency board 3. In this embodiment, the battery assembly provides electric energy for the radio frequency board 3, the radio frequency board 3 can generate microwaves, and feed the microwaves to the first microwave heating unit 1 by using the first microwave feed unit 2, so that the first microwave heating unit 1 forms a microwave field inside, and the microwave field can act on an aerosol generating article, thereby implementing microwave heating on the aerosol generating article.

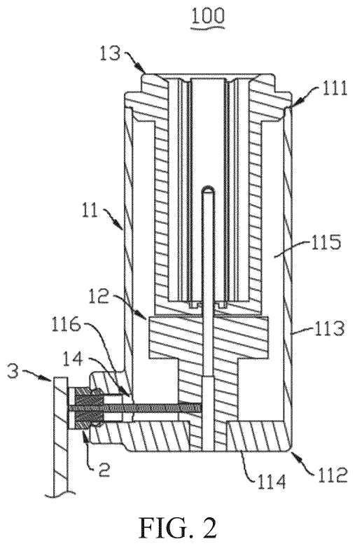

As shown in FIG. 1, the first microwave heating unit 1 is approximately a circular column in overall shape. Certainly, the first microwave heating unit 1 is not limited to being in a shape of the circular column, or may be in another shape such as a rectangular column or an elliptical column. The first microwave heating unit 1 may include a first outer conductor unit 11, a first inner conductor unit 12, and a first accommodating base 13, and further includes a first feed hole 14 (referring to FIG. 2) that communicates the interior of the first outer conductor unit 11 with the outside (where the outside refers to an external environment of the first microwave heating unit 1).

As shown in FIG. 2, the first outer conductor unit 11 is in a cylindrical shape, and has a first end 111 and a second end 112 that are opposite. The first inner conductor unit 12 is arranged coaxially in the first outer conductor unit 11, and is configured to adjust a resonance frequency and microwave distribution inside the first outer conductor unit 11. One end (namely, a first fixed end) of the first inner conductor unit 12 is connected to the second end 112 of the first outer conductor unit 11, forming a short-circuit end of the first microwave heating unit 1; and the other end (namely, the first free end) of the first inner conductor unit 12 extends toward the first end 111 of the first outer conductor unit 11, and is not in contact with the inner wall surface of the first outer conductor unit 11, forming an open-circuit end of the first microwave heating unit 1. The first accommodating base 13 is detachably mounted at the first end 111 of the first outer conductor unit 11, the partial structure of the first accommodating base 13 is arranged in the first outer conductor unit 11, and can define an accommodating cavity 1311 in the first outer conductor unit 11 for accommodating a lower structure of the aerosol generating article. The accommodating cavity 1311 is located in an area in which the microwave field is mainly formed.

In this embodiment, the first outer conductor unit 11 may be integrally formed by using a conductive metal material. The metal material is preferably aluminum alloy or copper. Certainly, the first outer conductor unit 11 is not limited to being integrally formed by using a conductive material, and may be formed by coating the inner wall surface of a non-conductive cylinder with a first conductive coating. The first conductive coating may be made of gold, silver, conductive metal oxide, or the like. Preferably, the first conductive coating is a silver coating or a gold coating.

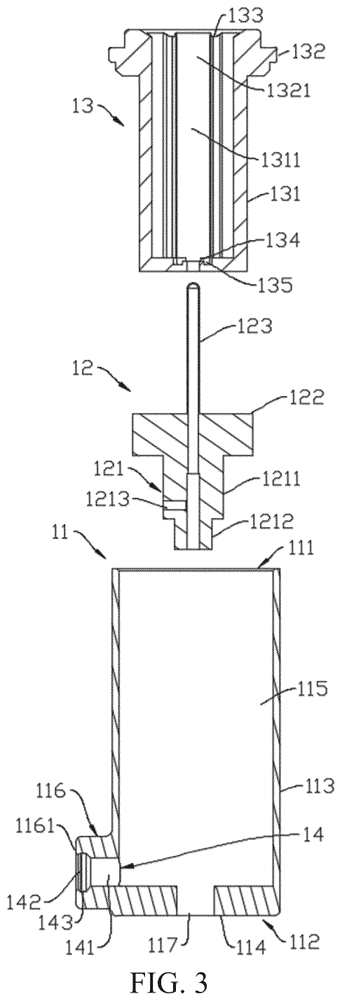

As shown in FIG. 2 and FIG. 3, the first outer conductor unit 11 may include a first conductor side wall 113 and a first conductor end wall 114 that are conductive. The first conductor side wall 113 may be in a cylindrical shape and includes a first open end and a second open end that are arranged oppositely. The first conductor end wall 114 is integrally closed at the second open end, to form a closed end of the first outer conductor unit 11 (namely, the second end 112 of the first outer conductor unit 11). The first open end forms an open end of the first outer conductor unit 11 (namely, the first end 111 of the first outer conductor unit 11). The first conductor end wall 114 and the first conductor side wall 113 together define a first cavity 115. The first cavity 115 is a semi-closed circular columnar channel. The aerosol generating article may extend into the first cavity 115 from the first open end.

The first conductor end wall 114 is further provided with a mounting hole 117 axially running through the first conductor end wall 114. The mounting hole 117 is configured for the bottom end of the first inner conductor unit 12 to mount therein.

The first outer conductor unit 11 further includes a first bump 116. The first bump 116 is rectangular, radially protrudes outward from a position on the first conductor side wall 113 close to the second open end, and is integrally formed on the outer peripheral wall surface of the first conductor side wall 113. The first bump 116 includes a sixth side surface 1161 away from the first conductor side wall 113, and the sixth side surface 1161 directly faces the radio frequency board 3.

As shown in FIG. 3, the first feed hole 14 is configured for embedding the first microwave feed unit 2 therein. The first feed hole 14 radially runs through the first bump 116 and the first conductor side wall 113, and openings of the first feed hole 14 are respectively formed on the inner peripheral wall of the first conductor side wall 113 and the sixth side surface 1161 of the first bump 116.

As shown in FIG. 3, the first inner conductor unit 12 may include a first conductor column 121, a first conductor disk 122 arranged above the first conductor column 121, and a first probe device 123 with an end embedded in the first conductor disk 122 and the first conductor column 121. Preferably, the axes of the first conductor column 121, the first conductor disk 122, the first probe device 123, and the first outer conductor unit 11 coincide with each other. It may be understood that, fed microwaves are transmitted to the first probe device 123 by using the first conductor column 121 and the first conductor disk 122, and a microwave field is formed at the periphery of the first probe device 123.

In this embodiment, the first conductor column 121 may be integrally formed by using a conductive metal material, and preferably, aluminum alloy or copper. Certainly, the first conductor column 121 is not limited to being integrally formed by using a conductive material, and may alternatively be formed by coating the outer surface of a non-conductor with a second conductive coating. The second conductive coating is preferably a silver coating or a gold coating.

The first conductor column 121 is configured in a step-like circular columnar shape. It may be understood that the first conductor column 121 is not limited to the shape of the circular column, and may alternatively be in another shape such as a rectangular column, an elliptical column, or an irregular column. The first conductor column 121 may include a first column portion 1211 and a second column portion 1212 that are integrally connected. The bottom end (namely, a second fixed end) of the second column portion 1212 is coaxially embedded in the mounting hole 117 of the first conductor end wall 114, and is in ohmic contact with the first conductor end wall 114. The diameter of the first column portion 1211 is greater than the diameter of the second column portion 1212, and the first column portion 1211 extends from the top end of the second column portion 1212 toward the first open end. The top end (namely, a second free end) of the first column portion 1211 is located below the first accommodating base 13.

A first insertion hole 1213 radially extending along the interior of the first column portion 1211 is provided on the outer peripheral wall surface of the first column portion 1211. The first insertion hole 1213 is a blind hole, an opening of the first insertion hole 1213 faces the first feed hole 14, and is configured for inserting the end of the first inner conductor 22 of the first microwave feed unit 2 into the first insertion hole 1213, so that reliable and good ohmic contact is formed between the first inner conductor 22 and the first conductor column 121. Certainly, the first insertion hole 1213 is not a necessary part in this embodiment, and is applied to this embodiment as an optional solution. The first insertion hole 1213 is configured for making a connection relationship between the first inner conductor 22 and the first conductor column 121 more reliable. When the first insertion hole 1213 is not provided, the end of the first inner conductor 22 of the first microwave feed unit 2 may directly abut against the outer peripheral wall surface of the first column portion 1211, to form ohmic contact.

In this embodiment, the first conductor disk 122 may be integrally formed by using a conductive metal material, and preferably, aluminum alloy or copper. Certainly, the first conductor disk 122 is not limited to being integrally formed by using a conductive material, and may alternatively be formed by coating the outer surface of a non-conductor with a third conductive coating. The third conductive coating is preferably a silver coating or a gold coating.

The first conductor disk 122 is in the shape of a disk, and the diameter of the first conductor disk 122 is greater than the diameter of the first column portion 1211 of the first conductor column 121 and less than the inner diameter of the first outer conductor unit 11. The first conductor disk 122 is integrally fitted to the top end of the first column portion 1211. Certainly, the first conductor disk 122 may alternatively be soldered onto the top end of the first column portion 1211, and is in ohmic contact with the first column portion 1211. It may be understood that, the first conductor disk 122 is not a necessary part in this embodiment, and is applied to this embodiment as an optional solution. The first conductor disk 122 may increase the inductance and the capacitance of the first conductor disk 122, and reduce the resonance frequency, so that the size of the first cavity 115 can be further reduced. When the first conductor disk 122 is not provided, microwave heating can still be implemented by using the first conductor column 121 and the first probe device 123 with the end embedded in the first conductor column 121.

In this embodiment, the first probe device 123 may include a first probe configured to adjust microwave field distribution and a microwave feed frequency. The first probe is in an elongated shape, and the lower portion of the first probe may be fixedly or detachably embedded in the first conductor disk 122 and the first conductor column 121, to form good ohmic contact with the first conductor disk 122 and the first conductor column 121. The upper end of the first probe extends upward and extends into the accommodating cavity 1311.

Preferably, the shape of the upper end portion of the first probe may include one of a plane, a sphere, an ellipsoid, a cone, or a truncated cone. The truncated cone is preferred because the truncated cone can enhance a local field strength, thereby increasing an atomization speed of the aerosol generating article.

Optionally, the first probe may be integrally formed by using a conductive metal material, and preferably, stainless steel, aluminum alloy, or copper. Certainly, the first probe is not limited to being integrally formed by using a conductive material, and may alternatively be formed by coating the outer surface of a non-conductor with a fourth conductive coating. The fourth conductive coating is preferably a silver coating or a gold coating.

The first probe device 123 may further include a temperature measurement element arranged in the first probe, and the temperature measurement element is configured to monitor the internal temperature of the aerosol generating article arranged in the first accommodating base 13. It may be understood that when temperature measurement is not required, the probe may be a solid structure; and when temperature measurement is required, the probe may be a hollow probe.

As shown in FIG. 3, the first accommodating base 13 may include a first accommodating portion 131 and a first fixing portion 132 integrally connected to the first accommodating portion 131. The first accommodating portion 131 is configured to define the accommodating cavity 1311. The first fixing portion 132 is configured to axially block the first open end of the first conductor side wall 113, and allow the first accommodating portion 131 to extend into the first cavity 115.

The first accommodating portion 131 may be cylindrical, and the outer diameter of the first accommodating portion 131 may be less than the inner diameter of the first conductor side wall 113. The first accommodating portion 131 defines an axial accommodating cavity 1311. The first fixing portion 132 may be annular and is coaxially connected to the first accommodating portion 131. The first fixing portion 132 may coaxially block the first open end of the first conductor side wall 113. The first fixing portion 132 includes an axial second through hole 1321 connecting the accommodating cavity 1311 to the outside, and the aerosol generating article may be inserted into the accommodating cavity 1311 through the second through hole 1321.

Preferably, the first accommodating base 13 further includes several elongated positioning ribs 133. The positioning ribs 133 are uniformly spaced circumferentially on the wall surfaces of the accommodating cavity 1311 and/or the second through hole 1321. Each positioning rib 133 extends in the direction parallel to the axis of the first accommodating base 13. The positioning ribs 133 may be configured to clamp the aerosol generating article inserted into the accommodating cavity 1311 and/or the through hole. In addition, a first air inlet channel longitudinal extending is formed between every two adjacent positioning ribs 133, so that air in the environment is conveniently drawn to the bottom of the aerosol generating article, and then enters the aerosol generating article, to carry the aerosol of the aerosol generating article generated through microwave heating.

Preferably, an air inlet gap 135 may further be provided below the accommodating cavity 1311, to prevent blocked air flow due to the bottom end surface of the aerosol generating article being completely covered. In this embodiment, the first accommodating portion 131 includes the inner side end surface abutting against the bottom end surface of the aircraft-forming article, and support ribs 134 that are uniformly spaced and radially distributed are arranged on the inner side end surface. The inner side end surface supports the aerosol generating article by using the support ribs 134. In addition, the support ribs 134 form several radial second air inlet channels (namely, the air inlet gaps 135). The second air inlet channels respectively communicate with the first air inlet channels, so that environment air is drawn into the bottom of the aerosol generating article, and then enters the aerosol generating article, to carry the aerosol generated by microwaves heating.

Optionally, the first accommodating base 13 may be made of a high-temperature-resistant material with a low dielectric loss, to reduce a proportion of microwave energy absorbed by the first accommodating base 13 and improve a heating (carbonization) effect of the aerosol generating article.

In this embodiment, the radio frequency board 3 may be arranged in the circumferential direction of the first microwave heating unit 1. The radio frequency board 3 may include a microstrip, a feedpoint connected to the microstrip, and a pair of pads located around the feedpoint. The pair of pads are symmetrically distributed on two opposite sides of the feedpoint. It should be noted that the radio frequency board 3 belongs to the existing technology. For a specific construction, refer to the existing technology. Details are not described herein again.

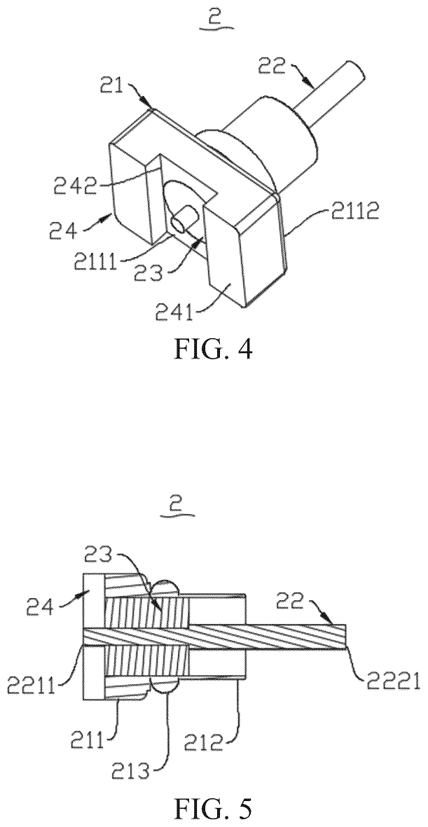

As shown in FIG. 4, the first microwave feed unit 2 may be a coaxial connector, which is inserted from the first feed hole 14, and is partially embedded in the first feed hole 14. The first microwave feed unit 2 includes a first outer conductor 21, a first inner conductor 22, a first dielectric layer 23, and a pair of first connecting conductors 24.

In this embodiment, as shown in FIG. 4 to FIG. 6, the first outer conductor 21 includes a mounting portion 211, an embedded portion 212, and a snap portion 213. The mounting portion 211 is of a rectangular sheet structure, and is located between an opening of the first feed hole 14 away from the first inner conductor unit 12 and the first connecting conductor 24. The mounting portion 211 includes a first surface 2111, a second surface 2112 opposite to the first surface 2111, and a first through hole 2113 running through the first surface 2111 and the second surface 2112. The first surface 2111 is relatively away from the first outer conductor unit 11. The embedded portion 212 is cylindrical and is embedded in the first feed hole 14. The end of the embedded portion 212 close to the mounting portion 211 is fitted to the second surface 2112 of the mounting portion 211, and a hollow channel of the embedded portion 212 is in communication with the first through hole 2113, The snap portion 213 may include an annular snap ring, and the snap ring is sleeved at the outer periphery of the embedded portion 212. When the embedded portion 212 is arranged in the first feed hole 14, the snap ring may be engaged on the inner wall surface of the first feed hole 14, so that good and reliable ohmic contact can be formed between the first outer conductor 21 and the first outer conductor unit 11.

It may be understood that the first feed hole 14 may include a first hole segment 141 and a second hole segment 142 that are coaxially connected. The first hole segment 141 is close to the first inner conductor unit 12, and the hole size of the first hole segment 141 fits the outer diameter of the embedded portion 212. The outer wall surface of the embedded portion 212 may be attached to the inner wall surface of the first hole segment 141. The inner diameter of the second hole segment 142 is greater than the inner diameter of the first hole segment 141, and the shape of the inner wall of the second hole segment 142 fits the shape of the snap ring. In this embodiment, the inner wall surface of the second hole segment 142 forms a circumferential first snap slot 143, and the first microwave feed unit 2 is engaged in the first snap slot 143 by using the snap portion 213 of the first microwave feed unit 2, to be reliably fixed in the first feed hole 14.

Preferably, to prevent the first outer conductor 21 and the connecting conductor from interfering with a radio frequency signal at a position of the feedpoint, a first spacing needs to be maintained between the feedpoint of the radio frequency board 3 and the first surface 2111 of the mounting portion 211. The size of the first spacing is not less than 0.5 mm.

As shown in FIG. 4, the pair of first connecting conductors 24 are symmetrically distributed on two opposite sides at the periphery of an opening of the first through hole 2113, a symmetry line of the pair of first connecting conductors 24 is parallel to the axis of the first outer conductor unit 11, and projection edges of the pair of first connecting conductors 24 close to the first through hole 2113 on the first surface 2111 are tangent to an edge of the opening of the first through hole 2113. Preferably, the first connecting conductor 24 is of a square sheet structure and includes a first side surface 241 and a second side surface 242 that are opposite. The first side surface 241 is relatively away from the first outer conductor unit 11 and is configured to be soldered onto the pad of the radio frequency board 3. The second side surface 242 is integrally fitted to the first surface 2111 of the mounting portion 211. It may be understood that the radio frequency board 3 and the first microwave heating unit 1 can be conducted by soldering the pair of first connecting conductors 24 onto the pad of the radio frequency board 3. The shape of the first connecting conductors 24 fits the shape of the pad, and a quantity of the first connecting conductors 24 corresponds to a quantity of the pads.

Preferably, to prevent the first outer conductor 21 and the connecting conductor from interfering with a radio frequency signal at the position of the feedpoint, a second spacing needs to be maintained between the feedpoint of the radio frequency board 3 and the wall surface of the first connecting conductor 24 facing the first inner conductor 22. The size of the second spacing is not less than 0.5 mm.

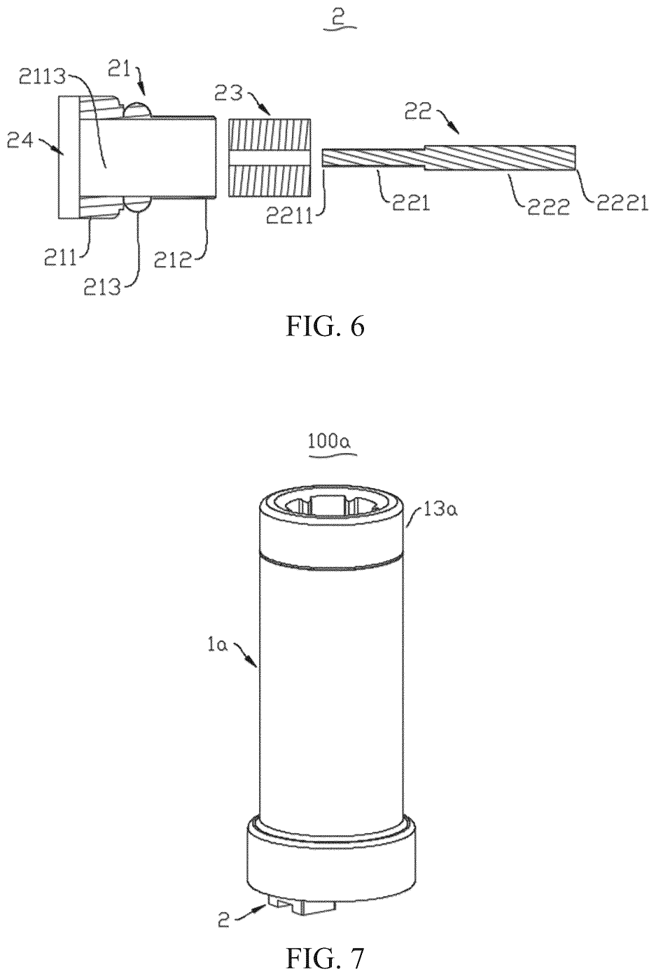

As shown in FIG. 2, FIG. 4, and FIG. 6, the first inner conductor 22 is partially arranged in the first outer conductor 21. The first inner conductor 22 is of a straight-line, needle-like structure, and may include a first needle segment 221 and a second needle segment 222 coaxially and integrally connected to the first needle segment 221. The first needle segment 221 is relatively away from the first outer conductor unit 11, and the end of the first needle segment 221 away from the second needle segment 222 is the access end 2211, configured to extend out of the first through hole 2113 to come into contact with the feedpoint of the radio frequency board 3. The diameter of the access end 2211 fits the diameter of the feedpoint, and the access end 2211 is located outside the first through hole 2113 and is flush with the first side surface 241 of the first connecting conductor 24. The diameter of the second needle segment 222 is greater than the diameter of the first needle segment 221, and the end of the second needle segment 222 away from the first needle segment 221 is a feed end 2221, configured to extend into the first cavity 115 and the first insertion hole 1213 of the first inner conductor unit 12, and abut against the inner wall surface of the first insertion hole 1213, to come into ohmic contact with the first inner conductor unit 12.

It may be understood that the first inner conductor 22 is not limited to being in a straight-line shape. In some other embodiments, the first inner conductor 22 may alternatively be in an L shape, and includes a first segment perpendicular to the axis of the first outer conductor unit 11 and a second segment parallel to the axis of the first outer conductor unit 11. The first segment is integrally connected to the second segment. The end (namely, the access end 2211) of the first segment away from the second segment is connected to the feedpoint of the radio frequency board 3. The end (namely, the feed end 2221) of the second segment away from the first segment is in ohmic contact with the inner wall surface of the first outer conductor unit 11 (for example, the inner wall surface of the first conductor end wall 114).

The first dielectric layer 23 may include a pair of insulators of an arc structure. The pair of insulators are between the first outer conductor 21 and the first inner conductor 22 and are symmetrically arranged in the circumferential direction of the first inner conductor 22, and inner concave side surfaces of the pair of insulators both face the outer peripheral surface of the first inner conductor 22.

It may be understood that, in Embodiment 1, by using the feature of the first outer conductor unit 11 being made of a conductive metal material or being formed by coating the inner wall surface of the non-conductive cylinder with the first conductive coating, the first feed hole 14 is provided on the first outer conductor unit 11 (it should be noted that a specific opening size conforms to a radio frequency connector design specification/an impedance matching specification), and a partial structure of the radio frequency connector assembly is transferred to the first outer conductor unit 11, so that the first outer conductor unit 11 has a function of an outer conductor of a radio frequency connector. In addition, an improved male radio frequency terminal (namely, the first microwave feed unit 2) may be directly embedded in the first feed hole 14, one end of the male radio frequency terminal is directly soldered onto the pad of the radio frequency board 3, and the other end of the male radio frequency terminal is directly in ohmic contact with the first microwave heating unit 1, and does not need to be combined with and connected to the first microwave heating unit 1 by using a female radio frequency terminal, thereby omitting the female radio frequency terminal. Such construction can simplify a structure and reduce a volume of the radio frequency connector assembly, which is beneficial to a miniaturized design of the aerosol generating device, and reduces costs. In addition, an assembly speed can be improved, connection reliability can be improved, and insertion loss can be reduced.

Referring to FIG. 7 together, the second microwave heating assembly 100a in Embodiment 2 of the present invention is shown. The second microwave heating assembly 100a is improved based on Embodiment 1. A difference between the second microwave heating assembly 100a and the first microwave heating assembly 100 in Embodiment 1 lies in that: The first microwave heating unit 1 in Embodiment 1 is replaced with a second microwave heating unit 1a.

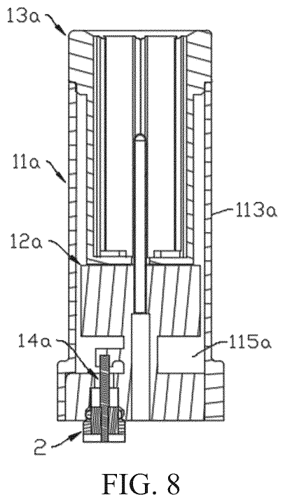

As shown in FIG. 7 and FIG. 8, the second microwave heating unit 1a is approximately a circular column in overall shape, may include a second outer conductor unit 11a, a second inner conductor unit 12a, and a second accommodating base 13a, and further includes a second feed hole 14a communicating the interior of the second outer conductor unit 11a with the outside.

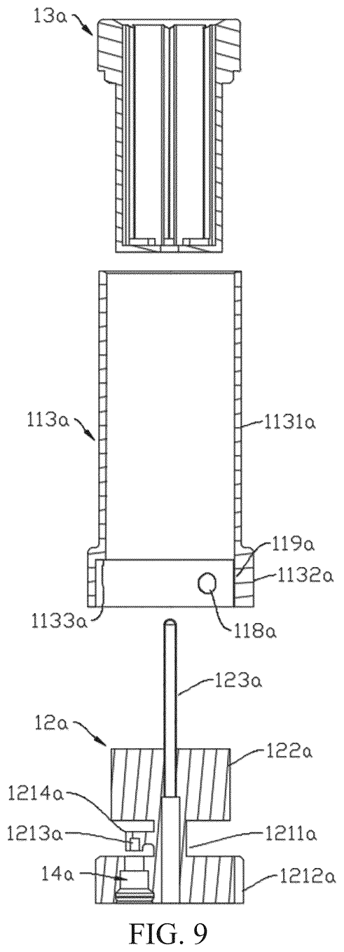

In this embodiment, the second outer conductor unit 11a is in a step-like cylindrical shape, and may be integrally formed by using a conductive metal material or by coating the inner wall surface of a non-conductive cylinder with the first conductive coating. As shown in FIG. 9, the second outer conductor unit 11a may include a conductive second conductor side wall 113a. The second conductor side wall 113a may be cylindrical, including a first cylinder segment 1131a and a second cylinder segment 1132a that are in communication longitudinally. The first cylinder segment 1131a is located above the second cylinder segment 1132a, the upper end of the first cylinder segment 1131a is of an open structure, and the lower end of the first cylinder segment 1131a is integrally connected to the upper end of the second cylinder segment 1132a. The lower end of the second cylinder segment 1132a is also of an open structure, and the inner diameter of the second cylinder segment 1132a is greater than the inner diameter of the first cylinder segment 1131a, so that a step surface 1133a is formed between the first cylinder segment 1131a and the second cylinder segment 1132a.

The second outer conductor unit 11a further includes a perforation 118a and a second bump 119a that are arranged on the second cylinder segment 1132a. The perforation 118a radially runs through the outer peripheral side wall of the second cylinder segment 1132a, and is formed on the second cylinder segment 1132a. The second bump is square, and is formed by radially protruding inward along the inner wall surface of the second cylinder segment 1132a. The perforation 118a and the second bump 119a are distributed at an interval in the circumferential direction of the second cylinder segment 1132a, and are both configured to cooperate with the second inner conductor unit 12a, to quickly fix the second inner conductor unit 12a in the second outer conductor unit 11a.

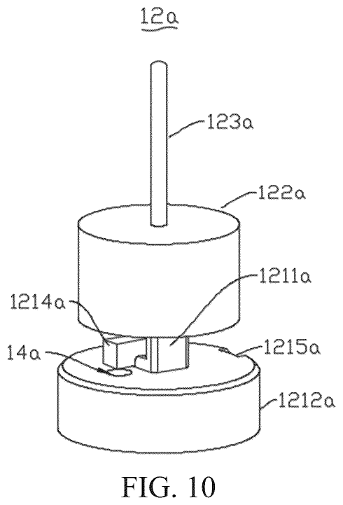

As shown in FIG. 9 and FIG. 10, the second inner conductor unit 12a may include a second conductor column 121a, a second conductor disk 122a arranged above the second conductor column 121a, and a second probe device 123a with an end embedded in the second conductor disk 122a and the second conductor column 121a. Preferably, the axes of the second conductor column 121a, the second conductor disk 122a, the second probe device 123a, and the second outer conductor unit 11a coincide with each other.

In this embodiment, the second conductor column 121a may be integrally formed by using a conductive metal material or by coating the outer surface of a non-conductor with the second conductive coating. The second conductor column 121a is in a shape of a step-like circular column, and may include a third column portion 1211a and a fourth column portion 1212a that are integrally connected. The fourth column portion 1212a is in a shape of a circular column, and the diameter of the fourth column portion 1212a fits the inner diameter of the second cylinder segment 1132a. The third column portion 1211a is in a shape of a square column, and the outer diameter of the third column portion 1211a is less than the inner diameter of the first cylinder segment 1131a and less than the diameter of the fourth column portion 1212a. The third column portion 1211a is located above the fourth column portion 1212a, and is integrally fitted to the top surface of the fourth column portion 1212a. The second conductor column 121a may be embedded into the inner wall of the second conductor side wall 113a from below the second conductor side wall 113a. The fourth column portion 1212a is accommodated in the second cylinder segment 1132a, the outer peripheral wall surface of the fourth column portion 1212a is attached to the inner peripheral wall surface of the second cylinder segment 1132a, and the top surface of the fourth column portion 1212a abuts against the step surface 1133a between the first cylinder segment 1131a and the second cylinder segment 1132a, so that good ohmic contact is formed between the fourth column portion 1212a and the second conductor side wall 113a. It may be understood that, the fourth column portion 1212a is configured to block the lower end of the second conductor side wall 113a, and a semi-closed second cavity 115a is formed between the fourth column portion 1212a and the first cylinder segment 1131a. The third column portion 1211a is located in the first cylinder segment 1131a, and the top end of the third column portion 1211a is configured to be connected to the second conductor disk 122a.

The second conductor column 121a further includes a through groove 1215a and a hole provided on the outer peripheral side wall of the fourth column portion 1212a. In an assembly process in which the second conductor column 121a is mounted on the second conductor side wall 113a, the through groove 1215a needs to be inserted into the second bump 119a, thereby successfully embedding the fourth column portion 1212a into the second cylinder segment 1132a. The through groove 1215a and the second bump 119a are designed to position the perforation 118a and the hole, so that the perforation 118a and the hole can quickly come into communication. In this case, a pin may be inserted through the through hole 118a into the hole, and is fixed in the through hole 118a and the hole, thereby fixing the second conductor column 121a in the second conductor side wall 113a. Optionally, the through groove 1215a is radially recessed inward along the outer peripheral side wall of the fourth column portion 1212a and formed, and the shape of the through groove 1215a fits the shape of the second bump 119a. The hole is also provided on the outer peripheral side wall of the fourth column portion 1212a, and is formed by extending inward along the outer peripheral side wall of the fourth column portion 1212a. The hole and the through groove 1215a are distributed at an interval on the outer peripheral side wall of the fourth column portion 1212a, and a position of the hole relative to the through groove 1215a corresponds to a position of the perforation 118a relative to the second bump 119a.

The second conductor column 121a further includes an extending portion 1214a radially extending outward along the outer peripheral side wall of the third column portion 1211a. The extending portion 1214a is configured to be in ohmic contact with the feed end 2221 of the first inner conductor 22 of the first microwave feed unit 2. Preferably, a second insertion hole 1213a is further provided on the wall surface of the extending portion 1214a facing the second feed hole 14a. The second insertion hole 1213a is a blind hole, and an opening of the second insertion hole 1213a is opposite to the second feed hole 14a and is configured for inserting the feed end 2221 of the first inner conductor 22 into the second insertion hole 1213a, so that the feed end 2221 abuts against the inner wall surface of the second insertion hole 1213a, and good and reliable ohmic contact is formed between the first inner conductor 22 and the second inner conductor unit 12a.

As shown in FIG. 8 to FIG. 10, the second feed hole 14a is configured for embedding the first microwave feed unit 2 therein. The second feed hole 14a is located at the periphery of the third column portion 1211a, runs through the upper end surface and the lower end surface of the fourth column portion 1212a in the direction parallel to the axial direction of the second outer conductor unit 11a, and is formed in the fourth column portion 1212a. It may be understood that for a specific configuration of the second feed hole 14a, reference may be made to the first feed hole 14, and details are not described herein again.

In this embodiment, the radio frequency board 3 may be arranged below the second microwave heating unit 1a.

It should be noted that for specific configurations and connection relationships of the second conductor disk 122a, the second probe device 123a, and the second accommodating base 13a in the second inner conductor unit 12a, reference may be made to the first conductor disk 122, the first probe device 123, and the first accommodating base 13 in Embodiment 1, and details are not described herein again.

It may be understood that, in Embodiment 2, similarly, by using the feature of the second inner conductor unit 12a being made of a conductive metal material or being formed by coating the inner wall surface of a non-conductive cylinder with the second conductive coating, the second feed hole 14a is provided on the second inner conductor unit 12a, and a partial structure of the radio frequency connector assembly is transferred to the second inner conductor unit 12a, so that the second inner conductor unit 12a has the function of the outer conductor of the radio frequency connector. For other specific functions, reference may be made to Embodiment 1, and details are not described herein again. It can be seen from FIG. 7 that, the second microwave heating unit 1a in Embodiment 2 is relatively longer and thinner than the first microwave heating unit 1 in Embodiment 1, further facilitating a miniaturized design of the aerosol generating device.

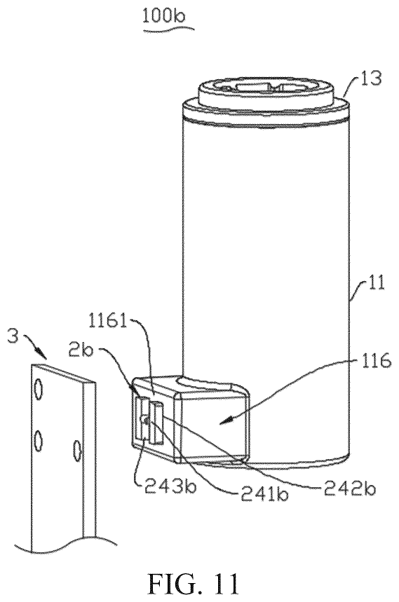

Referring to FIG. 11 together, the third microwave heating assembly 100b in Embodiment 3 of the present invention is shown. The third microwave heating assembly 100b is improved based on Embodiment 1. A difference between the third microwave heating assembly 100b and the first microwave heating assembly 100 in Embodiment 1 lies in that: The first microwave feed unit 2 in Embodiment 1 is replaced with the second microwave feed unit 2b. In addition, correspondingly, to match the second microwave feed unit 2b, the first feed hole 14 in Embodiment 1 is replaced with a third feed hole 14b.

In this embodiment, the third feed hole 14b is a circular columnar channel with a uniform inner diameter, and is formed in the first bump 116 of the first outer conductor unit 11 and the first conductor side wall 113.

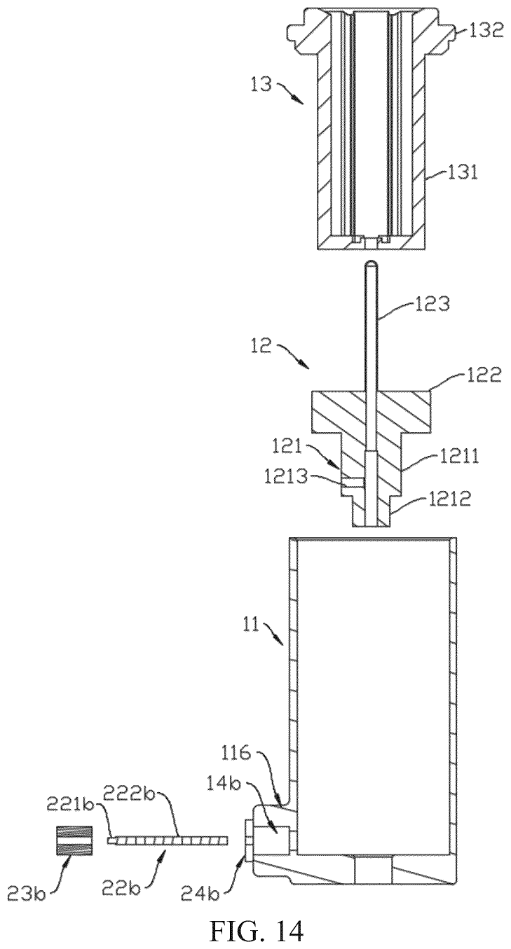

As shown in FIG. 14, the second microwave feed unit 2b includes a pair of second connecting conductors 24b, a second inner conductor 22b, and a second dielectric layer 23b.

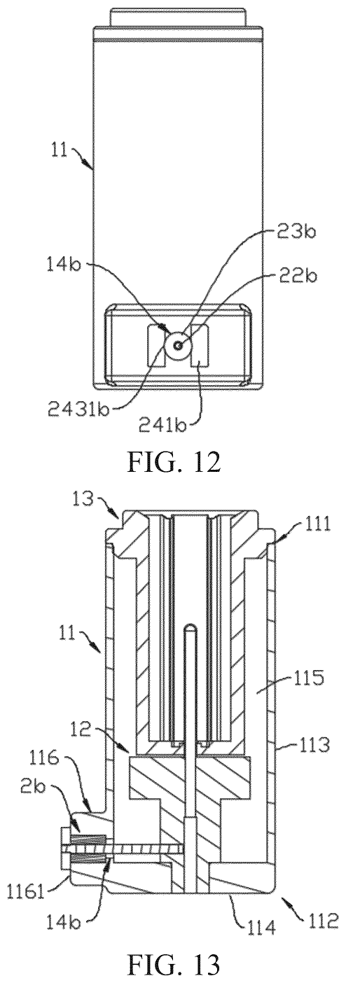

As shown in FIG. 11 to FIG. 13, the pair of second connecting conductors 24b are symmetrically distributed on two opposite sides at the periphery of an opening of the third feed hole 14b, and a symmetry line of the pair of second connecting conductors 24b is parallel to the axis of the first outer conductor unit 11. The second connecting conductor 24b is of a square sheet structure, and may include a third side surface 241b (equivalent to the first side surface 241 of the first connecting conductor 24) and a fourth side surface 242b (equivalent to the second side surface 242 of the first connecting conductor 24) that are opposite. The third side surface 241b is relatively away from the second outer conductor unit 11a, and is configured to be soldered onto the pad of the radio frequency board 3. The fourth side surface 242b is fitted to the sixth side surface 1161 of the first bump 116 (which may be integrally fitted, or may be soldered onto the sixth side surface 1161 of the first bump 116). The first outer conductor unit 11 and the radio frequency board 3 may be soldered by using the pair of second connecting conductor 24b, so that good ohmic contact is formed between the first outer conductor unit 11 and the radio frequency board 3.

The second connecting conductor 24b further includes a fifth side surface 243b connected between the third side surface 241b and the fourth side surface 242b, and the fifth side surface 243b faces the second inner conductor 22b. Preferably, an avoidance portion 2431b is provided at a position on the fifth side surface 243b opposite to the second inner conductor 22b. The avoidance portion 2431b is an arc groove, is recessed on the fifth side surface 243b in the direction away from the second inner conductor 22b and formed, and extends from the third side surface 241b toward the fourth side surface 242b. An objective of the avoidance portion 2431b is to maintain a spacing between the feedpoint of the radio frequency board 3 and the fifth side surface 243b, to prevent the second connecting conductor 24b from interfering with a radio frequency signal at the position of the feedpoint. Preferably, the spacing is not less than 0.5 mm. In addition, a third spacing may further be maintained between the feedpoint of the radio frequency board 3 and the sixth side surface 1161 of the first bump 116, to prevent the first bump 116 from interfering with a radio frequency signal at the position of the feedpoint. The size of the third spacing is not less than 0.5 mm.

As shown in FIG. 14, the second inner conductor 22b is partially arranged in the third feed hole 14b. The second inner conductor 22b is of a straight-line, needle-like structure, and may include a third needle segment 221b and a fourth needle segment 222b integrally connected to the third needle segment 221b. The third needle segment 221b is equivalent to the first needle segment 221 of the structure of the first inner conductor 22, the fourth needle segment 222b is equivalent to the second needle segment 222 of the structure of the first inner conductor 22. For a specific structure and connection relationship of the second inner conductor 22b, reference may be made to the first inner conductor 22, and details are not described herein again.

It may be understood that, the second inner conductor 22b is not limited to being in a straight-line shape, and may alternatively be in an L shape. For details, refer to related descriptions in Embodiment 1.

The second dielectric layer 23b may include a cylindrical insulating cylinder. The insulating cylinder is sleeved at the outer periphery of the second inner conductor 22b, the outer diameter of the insulating cylinder fits the inner diameter of the third feed hole 14b, and the outer peripheral wall surface of the insulating cylinder is attached to the inner wall surface of the third feed hole 14b, to fix the second inner conductor 22b to be coaxially located in the third feed hole 14b.

It may be understood that in Embodiment 3, based on Embodiment 1, the structure of the radio frequency connector assembly is further simplified, the male radio frequency terminal is canceled, the second connecting conductor 24b is directly fitted to the first bump 116 of the first outer conductor unit 11, and the second inner conductor 22b is supported by using the second dielectric layer 23b to be coaxially arranged in the third feed hole 14b, thereby implementing a microwave feed function. Such construction further simplifies the structure, further reduces the volume of the radio frequency connector assembly, and further facilitates a miniaturized design of the aerosol generating device, and further reduces costs.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A microwave heating assembly for an aerosol generating device, the microwave heating assembly comprising:
a microwave heating unit, comprising:
an outer conductor unit in a cylindrical shape,
an inner conductor unit arranged in the outer conductor unit, and
a feed hole communicating an interior of the outer conductor unit with an outside;
a radio frequency board; and
a microwave feed unit, comprising:
an inner conductor arranged in the feed hole and comprising a feed end and an access end,
wherein the feed end is in ohmic contact with an inner side of the outer conductor unit or the inner conductor unit, and
wherein an access end is in ohmic contact with the radio frequency board.

2. The microwave heating assembly of claim 1, wherein the microwave feed unit comprises a connecting conductor arranged at a periphery of an opening of the feed hole and protruding toward the outside, and
wherein the microwave heating unit is connected to the radio frequency board using the connecting conductor.

3. The microwave heating assembly of claim 2, wherein the microwave feed unit comprises an outer conductor; and the outer conductor comprises:
a mounting portion comprising a first surface, a second surface opposite to the first surface, and a first through hole running through the first surface and the second surface, the first surface being away from the outer conductor unit, the connecting conductor being fitted to the first surface; and
an embedded portion in a cylindrical shape and embedded in the feed hole, an end of the embedded portion close to the mounting portion being fitted to the second surface, a hollow channel of the embedded portion being in communication with the first through hole.

4. The microwave heating assembly of claim 3, wherein the connecting conductor is integrally fitted to the first surface, or
wherein the connecting conductor is in ohmic contact with the first surface.

5. The microwave heating assembly of claim 3, wherein at least one pair of connecting conductors is provided, the at least one pair of connecting conductors being symmetrically distributed on two opposite sides of an opening of the first through hole.

6. The microwave heating assembly of claim 3, wherein the outer conductor comprises a snap portion arranged at an outer periphery of the embedded portion,
wherein the snap portion is engaged on an inner wall surface of the feed hole, and
wherein the snap portion is in ohmic contact with the outer conductor unit.

7. The microwave heating assembly of claim 6, wherein the snap portion comprises a snap ring sleeved at an outer periphery of the embedded portion.

8. The microwave heating assembly of claim 6, wherein the feed hole comprises:
a first hole segment close to the inner conductor unit, an inner diameter of the first hole segment fitting an outer diameter of the embedded portion; and
a second hole segment coaxially connected to the first hole segment, an inner diameter of the second hole segment being greater than an inner diameter of the first hole segment,
wherein a the shape of the inner wall of the second hole segment fits the snap portion.

9. The microwave heating assembly of claim 3, wherein the microwave feed unit comprises a dielectric layer between the outer conductor and the inner conductor, and
wherein the dielectric layer is arranged in the through hole and/or the hollow channel.

10. The microwave heating assembly of claim 3, wherein the inner conductor comprises a straight-line, needle-like structure, and is coaxially arranged in the first through hole and the hollow channel.

11. The microwave heating assembly of claim 3, wherein the access end extends out of the first through hole, and is flush with a surface of the connecting conductor away from the microwave heating unit.

12. The microwave heating assembly of claim 11, wherein a first spacing is provided between a feedpoint of the radio frequency board and the first surface, and a size of the first spacing is not less than 0.5 mm, and
wherein a second spacing is provided between the feedpoint of the radio frequency board and a wall surface of the connecting conductor facing the inner conductor, and a size of the second spacing is not less than 0.5 mm.

13. The microwave heating assembly of claim 2, wherein the connecting conductor is integrally fitted to an outer surface of the microwave heating unit, or
wherein the connecting conductor is in ohmic contact with an outer surface of the microwave heating unit.

14. The microwave heating assembly of claim 13, wherein at least one pair of connecting conductors are provided, the at least one pair of connecting conductors being symmetrically distributed on two opposite sides of the opening of the feed hole.

15. The microwave heating assembly of claim 2, wherein an inner wall surface of the feed hole forms a circular columnar channel.

16. The microwave heating assembly of claim 15, wherein the microwave feed unit comprises a dielectric layer arranged in the feed hole,
wherein an outer diameter of the dielectric layer fits a hole size of the feed hole, and
wherein the dielectric layer is between an inner wall surface of the feed hole and an outer wall surface of the inner conductor.

17. The microwave heating assembly of claim 2, wherein the inner conductor comprises a straight-line, needle-like structure, and is coaxial with the feed hole.

18. The microwave heating assembly of claim 17, wherein the access end extends out of the feed hole, and is flush with a surface of the connecting conductor away from the microwave heating unit.

19. The microwave heating assembly of claim 13, wherein a third spacing is provided between a feedpoint of the radio frequency board and an outer surface of the microwave heating unit, and a size of the third spacing is not less than 0.5 mm, and
wherein a fourth spacing is provided between the feedpoint of the radio frequency board and a wall surface of the connecting conductor facing the inner conductor, and a size of the fourth spacing is not less than 0.5 mm.

20. The microwave heating assembly of claim 12, wherein the connecting conductor is provided with an avoidance portion recessed along a wall surface of the connecting conductor facing the inner conductor, and
wherein the avoidance portion is formed at a position of the wall surface of the connecting conductor facing the inner conductor and that is opposite to the inner conductor.

21. The microwave heating assembly of claim 2, wherein the outer conductor unit is cylindrical and comprises a first end, a second end, and a cavity between the first end and the second end, and
wherein the inner conductor unit is coaxially arranged in the cavity and comprises a first fixed end and a first free end, the first fixed end is connected to the second end, and the first free end extends toward the first end.

22. The microwave heating assembly of claim 21, wherein the outer conductor unit comprises a conductor side wall in a cylindrical shape, and
wherein the conductor side wall comprises a first open end and a second open end that are opposite.

23. The microwave heating assembly of claim 22, wherein the inner conductor unit comprises:
a conductor column comprising a second fixed end and a second free end,
wherein the second fixed end is coaxially connected to an inner side of the outer conductor unit, and
wherein the second free end extends toward the first open end.

24. The microwave heating assembly of claim 23, wherein the outer conductor unit comprises a conductor end wall, and the conductor end wall integrally blocks at the second open end,
wherein the conductor column comprises a first column portion and a second column portion that are coaxially connected,
wherein the second column portion is embedded in the conductor end wall and is in ohmic contact with the conductor end wall, and
wherein the first column portion extends from an end of the second column portion close to the first open end toward the first open end.

25. The microwave heating assembly of claim 23, wherein the conductor side wall comprises a first cylinder segment and a second cylinder segment that are coaxially connected,
wherein the first cylinder segment is away from the second end of the outer conductor unit,
wherein an inner diameter of the first cylinder segment is less than an inner diameter of the second cylinder segment,
wherein the conductor column comprises a third column portion and a fourth column portion that are coaxially connected,
wherein the fourth column portion is embedded in the second cylinder segment,
wherein an outer surface of the fourth column portion is attached to an inner wall surface of the second cylinder segment and is in ohmic contact with the second cylinder segment,
wherein a diameter of the third column portion is less than a diameter of the first cylinder segment, and
the third column portion is located in the first cylinder segment.

26. The microwave heating assembly of claim 25, wherein the microwave heating unit comprises a pin configured to fix the fourth column portion in the second cylinder segment, and
wherein the pin passes through an outer peripheral side wall of the second cylinder segment, and is inserted into the fourth column portion.

27. The microwave heating assembly of claim 26, wherein a second bump is arranged on the second cylinder segment so as to limit embedding of the fourth column portion in a circumferential direction,
wherein the second bump protrudes inward along an inner wall surface of the second cylinder segment, and
wherein the fourth column portion is provided with a through groove matching the second bump and recessed inward along an outer peripheral side wall of the fourth column portion.

28. The microwave heating assembly of claim 24, wherein a first bump is arranged at a position on the conductor side wall close to the second open end, and
wherein the feed hole radially runs through a conductor side wall and the first bump, and is formed in the conductor side wall and the first bump.

29. The microwave heating assembly of claim 24, wherein the feed hole runs through the conductor end wall in the direction parallel to an axial direction of the outer conductor unit and is formed on the conductor end wall.

30. The microwave heating assembly of claim 25, wherein the feed hole runs through the fourth column portion in a direction parallel to an axial direction of the outer conductor unit and is formed in the fourth column portion.

31. The microwave heating assembly of claim 28, wherein a first insertion hole extending in a radial direction of the conductor column is provided on an outer peripheral wall of the conductor column,
wherein the first insertion hole is opposite to the feed hole, and
wherein the feed end is inserted into the first insertion hole, and is in ohmic contact with the conductor column.

32. The microwave heating assembly of claim 29, wherein the inner conductor unit comprises an extending portion fitted to an outer surface of the conductor column, and
wherein the extending portion extends outward in a direction perpendicular to an axis direction of the conductor column and is in ohmic contact with the feed end.

33. The microwave heating assembly of claim 32, wherein the extending portion is provided with a second insertion hole for inserting the feed end, and
wherein an opening of the second insertion hole is opposite to the feed hole.

34. The microwave heating assembly of claim 23, wherein the inner conductor unit comprises:
a conductor disk coaxially connected to the second free end,
wherein a diameter of the conductor disk is greater than a diameter of the conductor column and less than an inner diameter of the cavity.

35. The microwave heating assembly of claim 34, wherein the inner conductor unit comprises:
a probe device in an elongated shape,
wherein one end of the probe device is embedded in the conductor disk, and
wherein an other end of the probe device extends toward the first open end.

36. The microwave heating assembly of claim 22, further comprising:
an accommodating base mounted on the first open end, the accommodating base comprising an accommodating portion configured to accommodate an aerosol generating article,
wherein the accommodating portion is located in the cavity.

37. An aerosol generating device, comprising:
a battery assembly;
the microwave heating assembly of claim, and
wherein the battery assembly is electrically connected to the radio frequency board.
